(19) United States
(12) Patent Application Publication
(10) Pub. No.: US 2011/0310945 A1
(43) Pub. Date: Dec. 22, 2011

(54) RADIO COMMUNICATION APPARATUS AND RADIO COMMUNICATION METHOD

(75) Inventor: Hirotaka Sato, Kanagawa (JP)

(73) Assignee: KYOCERA CORPORATION, Kyoto (JP)

(21) Appl. No.: 13/203,207

(22) PCT Filed: Feb. 24, 2010
(86) PCT No.: PCT/JP2010/001261

§ 371 Date: Aug. 24, 2011

(30) Foreign Application Priority Data
Feb. 25, 2009 (JP) 2009-042973

(51) Int. Cl. H04W 24/00

(52) U.S. Cl. 375/224

(57) ABSTRACT

Provided are a radio communication apparatus and a radio communication method capable of changing an order of interpolation between time domain interpolation and frequency domain interpolation based on a degree of channel variation. According to the present invention, a radio communication apparatus (100) includes a pilot channel estimation unit (30) for estimating a channel estimation value from pilot symbols, a channel statistics information estimation unit (40, 50) for estimating channel statistics information on a degree of channel variation in at least one of the time domain and the frequency domain, an interpolation domain order determination unit (60) for determining the order of channel interpolation in the time domain and in the frequency domain, and an interpolation unit (70) for performing channel interpolation in the time domain and in the frequency domain. The interpolation unit, in the order determined by the interpolation domain order determination unit, first performs one of the channel interpolation in the time domain and in the frequency domain by using the channel estimation value and then performs the other channel interpolation by using the channel estimation value and a channel interpolation value obtained by a first channel interpolation.

### CROSS REFERENCE TO RELATED APPLICATION

This application claims priority to and the benefit of Japanese Patent Application No. 2009-42973 (filed on Feb. 25, 2009), the entire contents of which are incorporated herein by reference.

### TECHNICAL FIELD

The present invention relates to radio communication apparatuses and radio communication methods, and in particular to radio communication apparatuses and radio communication methods for performing channel interpolation by using pilot symbols scattered in a time domain and a frequency domain.

### BACKGROUND ART

In radio communications, the data to be communicated is generally transmitted over a channel whose characteristics vary in a time direction and in a frequency direction. That is, the amplitude and phase of a channel change from one symbol to the next symbol and from one frequency to the next frequency. A general method to estimate a varying channel is to insert known symbols (so-called pilot symbols) into a sequence to be transmitted. For example, in systems based on orthogonal frequency division multiplexing (OFDM), pilot symbols scattered in different several carriers are transmitted to aid channel estimation. FIG. 7 is a diagram illustrating an example of arrangement of the pilot symbols in the OFDM system.

FIG. 8 is a diagram illustrating a schematic configuration of a conventional radio communication apparatus (see Patent Document 1). In a radio communication apparatus 200, a received baseband signal, output from the RF front-end 110, is OFDM-demodulated by an FFT unit 120, and input to a pilot signal extraction unit 160 and a dividing circuit 180. In addition, the received baseband signal output from the RF front-end 110 is input to an SNR estimation unit 130, a Doppler spread estimation unit 140 and a delay spread estimation unit 150, by which a received SNR, a Doppler spread and a delay spread are estimated respectively. The pilot signal extraction unit 160 extracts the pilot signal from the input signal and outputs the pilot signal to a time interpolation filter 171. The time interpolation filter 171 selects a time interpolation filter coefficient among a plurality of predetermined time interpolation filter coefficients based on the SNR input from the SNR estimation unit 130 and the Doppler spread input from the Doppler spread estimation unit 140. The time interpolation filter 171 performs time interpolation filtering on the pilot signal by using the selected coefficient and provides output thereof to a frequency interpolation filter 172. The frequency interpolation filter 172 selects a frequency interpolation filter coefficient among a plurality of predetermined frequency interpolation filter coefficients based on the SNR input from the SNR estimation unit 130 and the delay spread input from the delay spread estimation unit 150. The frequency interpolation filter 172 performs frequency interpolation by using the selected coefficient and outputs a channel interpolation value to the dividing circuit 180. The dividing circuit 180 removes a channel distortion included in a signal output from an FFT unit 120 by performing equalization with the channel interpolation value output from the frequency interpolation filter 172. Next, the dividing circuit 180 outputs an equalized signal to an additional processing unit 190 for error correction and the like.

It is assumed that a channel interpolation is performed in a time domain and in a frequency domain based on the arrangement of the pilots shown in FIG. 7 in the conventional radio communication apparatus described above. In this case, if interpolation in the time domain is first performed by using a channel estimation value of the pilot symbols, the conventional radio communication apparatus can use the channel interpolation value obtained by interpolation in the time domain, in addition to the channel estimation value of the pilot symbols, for following interpolation in the frequency domain. For example, since the time interpolation is highly accurate when channel variation is mild in the time domain, an accuracy in interpolation in the frequency domain can be improved by using the channel interpolation value obtained by interpolation in the time domain in addition to the channel estimation value of the pilot symbols, rather than the interpolation by using only the channel estimation value of the pilot symbols.

### PRIOR ART DOCUMENT

### Patent Document

Patent Document 1: JP 2007-511942 T

### SUMMARY OF INVENTION

### Technical Problem

However, in the radio communication apparatus in Patent Document 1, the order of interpolation (first time interpolation and then frequency interpolation, or first frequency interpolation and then time interpolation) is fixed without depending on a degree of the channel variation in the frequency domain and that in the time domain. For example, if the order of interpolation is fixed, such as first time interpolation and then frequency interpolation, accuracy in time interpolation becomes lower when the channel varies widely in the time domain. Therefore, there is a problem that, if the channel interpolation value obtained by the interpolation in the time domain is used for the interpolation in the frequency domain in addition to the channel estimation value of the pilot symbols, the accuracy in interpolation in the frequency domain becomes lower than interpolation using the channel estimation value of the pilot symbols alone. That is, if the channel varies widely in the time domain while the channel varies mildly in the frequency domain, the accuracy in the interpolation in the frequency domain is deteriorated because of error propagation caused by interpolation in the frequency domain using the channel interpolation value of the time domain having a large error, resulting in deterioration of accuracy in estimation of overall channel. Even if the order of interpolation is fixed, such as the frequency interpolation first and then the time interpolation, a similar problem will be occurred if the channel varies widely in the frequency domain while the channel varies mildly in the time domain.

Accordingly, it is an object of the present invention, in consideration of such problems, to provide radio communication apparatuses and radio communication methods capable of changing the order of interpolation between the time domain interpolation and the frequency domain interpolation based on a degree of the channel variation.

### Solution to Problem

In order to solve the above problems, a radio communication apparatus according to claim 1 is a radio communication apparatus for interpolating a channel by using pilot symbols scattered in a time domain and a frequency domain, including:

a pilot channel estimation unit for estimating a channel estimation value from the pilot symbols;

a channel statistics information estimation unit for estimating channel statistics information on a degree of channel variation in at least one of the time domain and in the frequency domain from a received signal;

an interpolation domain order determination unit for determining an order of channel interpolation in the time domain and in the frequency domain based on the channel statistics information; and

an interpolation unit for performing the channel interpolation in the time domain and in the frequency domain, wherein the interpolation unit, in the order determined by the interpolation domain order determination unit, first performs either of the channel interpolation in the time domain and in the frequency domain as a first channel interpolation by using the channel estimation value and then performs channel interpolation different from the first channel interpolation in the channel interpolation in the time domain and in the frequency domain, as a second channel interpolation, by using the channel estimation value and a channel interpolation value obtained by the first channel interpolation.

The invention according to claim 2 is the radio communication apparatus described in claim 1, wherein

the channel statistics information estimation unit estimates a maximum Doppler frequency indicating the degree of channel variation in the time domain from the received signal,

the interpolation domain order determination unit determines the order of channel interpolation such that if the maximum Doppler frequency is smaller than a threshold, the channel interpolation in the time domain is first performed and then the channel interpolation in the frequency domain is performed, and

if the maximum Doppler frequency is larger than the threshold, the channel interpolation in the frequency domain is first performed and then the channel interpolation in the time domain is performed.

The invention according to claim 3 is the radio communication apparatus described in claim 1, wherein

the channel statistics information estimation unit estimates a delay spread indicating the degree of channel variation in the frequency domain from the received signal and,

the interpolation domain order determination unit determines the order of channel interpolation such that if the delay spread is smaller than a threshold, the channel interpolation in the frequency domain is first performed and then the channel interpolation in the time domain is performed, and

if the delay spread is larger than the threshold, the channel interpolation in the time domain is first performed and then the channel interpolation in the frequency domain is performed.

The invention according to claim 4 is the radio communication apparatus described in claim 1, wherein

the channel statistics information estimation unit estimates a maximum Doppler frequency indicating the degree of channel variation in the time domain and a delay spread indicating the degree of channel variation in the frequency domain and obtains a channel variation amount in the time domain corresponding to the maximum Doppler frequency and a channel variation amount in the frequency domain corresponding to the delay spread, and

the interpolation unit determines the order of channel interpolation such that if the channel variation amount in the time domain is smaller than the channel variation amount in the frequency domain, the channel interpolation in the time domain is first performed, and then the channel interpolation in the frequency domain is performed, and

if the channel variation in the frequency domain is smaller than the channel variation in the time domain, the channel interpolation in the frequency domain is first performed and then the channel interpolation in the time domain is performed.

In the above description, the means for solving the problem according to the present invention has been described as an apparatus. However, it should be understood that the present invention can also be implemented as a method, a program, and a storage medium for storing the program and they are included in the scope of the present invention.

For example, a radio communication method according to claim 5, as a method implementing the present invention, is a radio communication method for interpolating a channel by using pilot symbols scattered in a time domain and a frequency domain, including the steps of:

estimating a channel estimation value from the pilot symbols;

estimating channel statistics information on a degree of channel variation in at least one of a time domain and a frequency domain from a received signal;

determining an order of interpolation domain to determine an order of channel interpolation in the time domain and in the frequency domain based on the channel statistics information; and

performing channel interpolation in the time domain and in the frequency domain, wherein

at the step of performing interpolation, in the order determined at the step of determining the order of interpolation domain, either of the channel interpolation in the time domain and in the frequency domain is first performed as a first channel interpolation by using the channel estimation value, and then channel interpolation different from the first channel interpolation in the channel interpolation in the time domain and in the frequency domain is performed as a second channel interpolation by using the channel estimation value and a channel interpolation value obtained by the first channel interpolation.

### EFFECT OF THE INVENTION

The radio communication apparatus according to the present invention can improve accuracy in the channel interpolation by changing the order of interpolation between the time domain interpolation and the frequency domain interpolation.

### BRIEF DESCRIPTION OF DRAWINGS

FIG. 1 is a diagram illustrating a schematic configuration of a radio communication apparatus according to an embodiment of the present invention;

FIG. 2 is a flowchart illustrating a first interpolation domain order determination method by the radio communication apparatus shown in FIG. 1;

FIG. 3 is a flowchart illustrating a second interpolation domain order determination method by the radio communication apparatus shown in FIG. 1;

FIG. 4 is a flowchart illustrating a third interpolation domain order determination method by the radio communication apparatus shown in FIG. 1;

FIG. 5 is a diagram illustrating an example of a table of amounts of channel variations in the time domain to maximum Doppler frequencies;

FIG. 6 is a diagram illustrating an example of a table of amounts of channel variations in the frequency domain to delay spreads;

FIG. 7 is a diagram illustrating an example of arrangement of pilot symbols in OFDM system; and

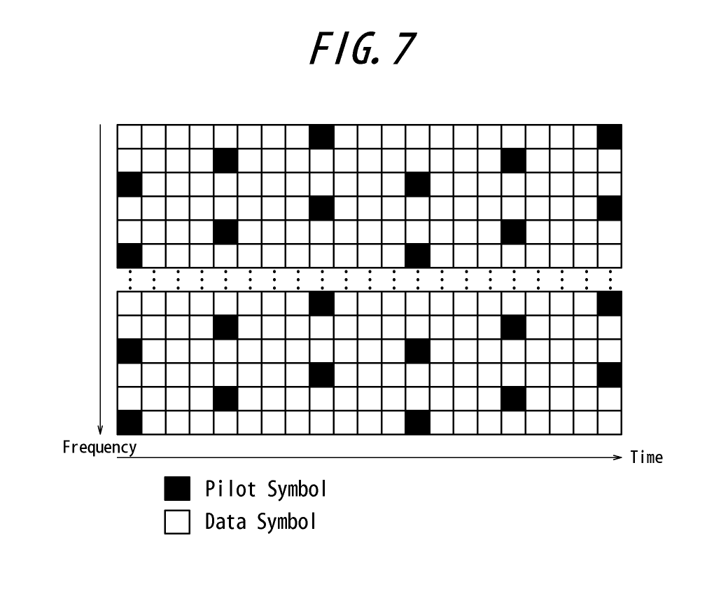

FIG. 8 is a diagram illustrating a schematic configuration of a conventional radio communication apparatus.

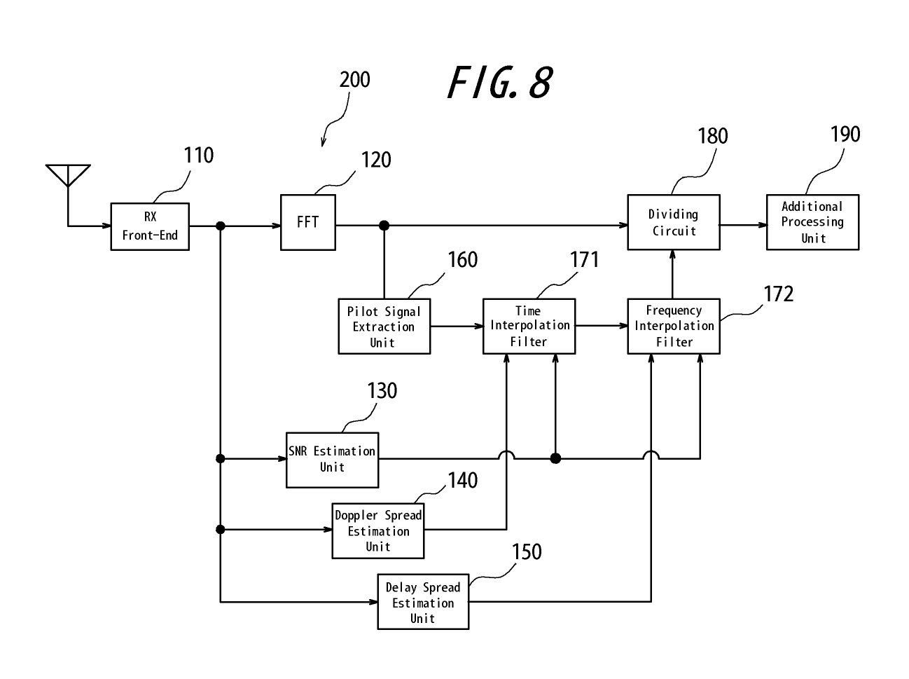

### DESCRIPTION OF EMBODIMENT

Embodiments of the present invention will be described with reference to the accompanying drawings. The present embodiment uses delay spread (for determining a variation in a frequency domain) and a maximum Doppler frequency (for determining a variation in a time domain) as channel statistics information for determining a degree of channel variation. However, it should be noted that the channel statistics information included in the scope of the present invention is not limited to the delay spread and the maximum Doppler frequency.

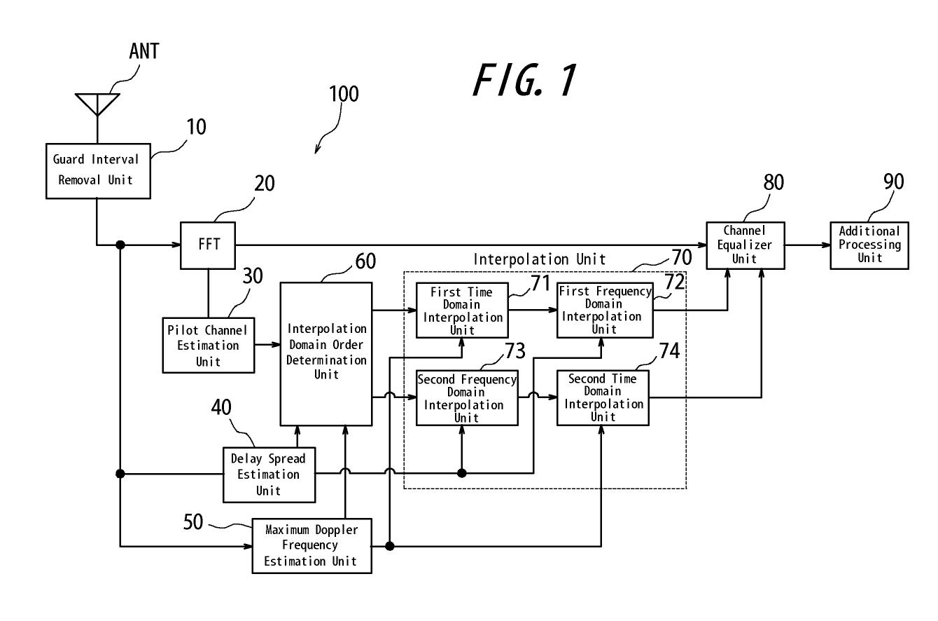

FIG. 1 is a diagram illustrating a schematic configuration of a radio communication apparatus according to an embodiment of the present invention. A radio communication apparatus 100 has a reception antenna ANT, a guard interval removal unit 10, an FFT unit 20, a pilot channel estimation unit 30, a delay spread estimation unit 40 and a maximum Doppler frequency estimation unit 50 as the channel statistics information estimation unit, an interpolation domain order determination unit 60, an interpolation unit 70, a channel equalizer unit 80, and an additional processing unit 90. The interpolation unit 70 has a first time domain interpolation unit 71, a first frequency domain interpolation unit 72, a second frequency domain interpolation unit 73 and a second time domain interpolation unit 74. The guard interval removal unit 10, the FFT unit 20, the pilot channel estimation unit 30, the delay spread estimation unit 40, the maximum Doppler frequency estimation unit 50, the interpolation domain order determination unit 60, the interpolation unit 70 (the first time domain interpolation unit 71, the first frequency domain interpolation unit 72, the second frequency domain interpolation unit 73 and the second time domain interpolation unit 74), the channel equalizer unit 80 and the additional processing unit 90 may be implemented by a software executed by any suitable processor such as CPU (Central Processing Unit) or the like or they may be implemented by dedicated processors for respective processes (for example, DSP (Digital Signal Processor)).

The guard interval removal unit 10 removes a guard interval from a received baseband OFDMA (Orthogonal Frequency Division Multiple Access) signal input from the reception antenna ANT. Next, the received OFDMA signal is input to the FFT unit 20, the delay spread estimation unit 40 and the maximum Doppler frequency estimation unit 50.

The FFT unit 20 converts the received baseband OFDMA signal into a signal of the frequency domain and outputs such a converted signal to the channel equalizer unit 80 and the pilot channel estimation unit 30. The pilot channel estimation unit 30 calculates a channel estimation value of the pilot symbols and outputs the channel estimation value to the interpolation domain order determination unit 60.

The delay spread estimation unit 40 and the maximum Doppler frequency estimation unit 50 estimate a delay spread σₜ and a maximum Doppler frequency f_{D}, respectively, as the channel statistics information, from the received baseband OFDMA signal and output the estimated delay spread σₜ and the estimated maximum Doppler frequency f_{D} to the interpolation domain order determination unit 60.

The interpolation order determination unit 60 determines which interpolation, the time domain interpolation or the frequency domain interpolation, is performed first based on the channel statistics information input, that is, the maximum Doppler frequency f_{D} and the delay spread σₜ.

When the time domain interpolation is performed first, the interpolation domain order determination unit 60 outputs the channel estimation value of the pilot symbols input by the pilot channel estimation unit 30 to the first time domain interpolation unit 71. The first time domain interpolation unit 71 performs the time domain interpolation by using the channel estimation value of the pilot symbols and outputs a time domain interpolation value and the channel estimation value of the pilot symbols to the first frequency domain interpolation unit 72. Next, the first frequency domain interpolation unit 72 performs the frequency domain interpolation by using the channel estimation value of the pilot symbols and the time domain interpolation value and outputs a channel interpolation value to the channel equalizer unit 80.

When the frequency domain interpolation is performed first, the interpolation domain order determination unit 60 outputs the channel estimation value of the pilot symbols input by the pilot channel estimation unit 30 to the second frequency domain interpolation unit 73. The second frequency domain interpolation unit 73 performs the frequency domain interpolation by using the channel estimation value of the pilot symbols and outputs a frequency domain interpolation value and the channel estimation value of the pilot symbols to the second time domain interpolation unit 74. Next, the second time domain interpolation unit 74 performs the time domain interpolation by using the channel estimation value of the pilot symbols and the frequency domain interpolation value and outputs the channel interpolation value to the channel equalizer unit 80.

Time domain interpolation methods by the first time domain interpolation unit 71 and the second time domain interpolation unit 74 may be fixed. It is also possible to switch interpolation methods based on the maximum Doppler frequency, for example, by using an average of the channel estimation values of the pilot symbols when there is almost no channel variation, linear interpolation when the channel varies mildly, and interpolation by Wiener filter when the channel varies widely.

Similarly, frequency domain interpolation methods by the first frequency domain interpolation unit 72 and the second frequency domain interpolation unit 73 may be fixed. It is also possible to switch interpolation methods based on the delay spread, for example, by using the average of the channel estimation values of the pilot symbols when there is almost no channel variation, the linear interpolation when the channel varies mildly, and the interpolation by Wiener filter when the channel varies widely.

The channel equalizer unit 80 performs channel equalization on the received OFDMA signal of the frequency domain output from the FFT unit 20 by using the channel interpolation value which is input, and then outputs the signal after the channel equalization to the additional processing unit 90. The additional processing unit 90 performs an error correction decoding and the like on the input signal.

The following is a description of operations by the radio communication apparatus 100 with reference to a flowchart.

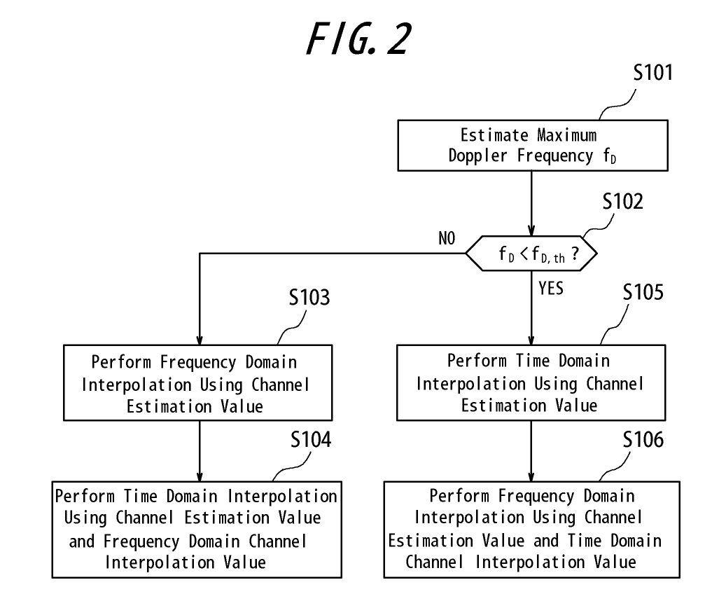

FIG. 2 is a flowchart illustrating a first interpolation domain order determination method by the radio communication apparatus 100 and illustrates processing of the interpolation domain order determination unit 60 to determine an order of the interpolation domains by using the maximum Doppler frequency as the channel statistics information for determining the degree of channel variation. The first interpolation domain order determination method does not need the delay spread as the channel statistics information in determining the degree of channel variation. Therefore, it is to be noted that the first interpolation domain order determination method can be performed by a radio communication apparatus which is configured by removing the delay spread estimation unit 40 from the radio communication apparatus 100 (that is, the maximum Doppler frequency estimation unit 50 constitutes the channel statistics information estimation unit. A configuration of this radio communication apparatus is now shown).

First, the maximum Doppler frequency estimation unit 50 estimates the maximum Doppler frequency f_{D} from the received baseband signal and outputs the maximum Doppler frequency f_{D} to the interpolation domain order determination unit 60 (step S101). The interpolation domain order determination unit 60 compares the maximum Doppler frequency fᵤ and a predetermined threshold f_{D,th} (step S102). The threshold f_{D,th} may be determined optimally by transmission simulation.

If f_{D}<f_{D,th} (YES of step S102), the interpolation domain order determination unit 60 determines that the channel variation in the time domain is small and thus determines to perform channel interpolation in the time domain first by using the channel estimation value of the pilot symbols. In this case, the first time domain interpolation unit 71 performs the time domain interpolation by using the channel estimation value of the pilot symbols (step S105). The first frequency domain interpolation unit 72 performs the frequency domain interpolation by using the channel estimation value of the pilot symbols and the time domain interpolation value (step S106).

If f_{D}≧_{D,th} (NO of step S102), the interpolation domain order determination unit 60 determines that the channel variation in the time domain is large and thus determines to perform the channel interpolation in the frequency domain first by using the channel estimation value of the pilot symbols. In this case, the second frequency domain interpolation unit 73 performs the frequency domain interpolation by using the channel estimation value of the pilot symbols (step S103). The second time domain interpolation unit 74 performs the time domain interpolation by using the channel estimation value of the pilot symbols and the frequency domain interpolation value (step S104).

As discussed above, since the first interpolation domain order determination method uses the maximum Doppler frequency as the channel statistics information and changes the order of interpolation between the time domain interpolation and the frequency domain interpolation based on the degree of channel variation in the time domain, it can improve accuracy in the channel interpolation.

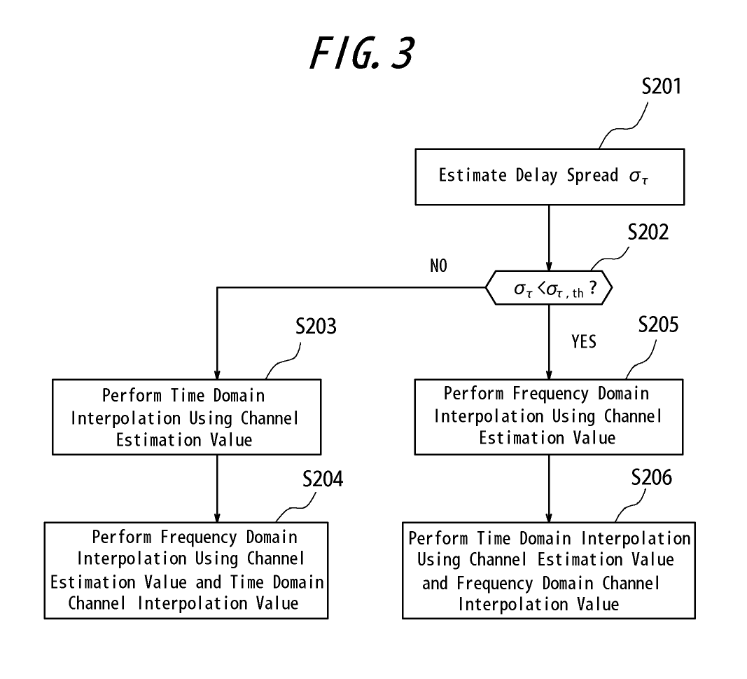

FIG. 3 is a flowchart illustrating a second interpolation domain order determination method by the radio communication apparatus 100 and illustrates processing of the interpolation domain order determination unit 60 to determine the order of the interpolation domains by using the delay spread as the channel statistics information for determining the degree of channel variation. The second interpolation domain order determination method does not need the maximum Doppler frequency as the channel statistics information in determining the degree of channel variation. Therefore, it is to be noted that the second interpolation domain order determination method can be performed by a radio communication apparatus which is configured by removing the maximum Doppler frequency estimation unit 50 from the radio communication apparatus 100 (that is, the delay spread estimation unit 40 constitutes the channel statistics information estimation unit. A configuration of this radio communication apparatus is now shown).

First, the delay spread estimation unit 40 estimates the delay spread σₜ from the received baseband signal and outputs the delay spread σₜ to the interpolation domain order determination unit 60 (step S201). The interpolation domain order determination unit 60 compares the delay spread σₜ and a predetermined threshold σ_{t,th} (step S202). The threshold σ_{t,th} may be determined optimally by the transmission simulation.

If σₜ<σ_{t,th} (YES of step S202), the interpolation domain order determination unit 60 determines that the channel variation in the frequency domain is small and thus determines to perform the channel interpolation in the frequency domain first by using the channel estimation value of the pilot symbols. In this case, the second frequency domain interpolation unit 73 performs the frequency domain interpolation by using the channel estimation value of the pilot symbols (step S205). The second time domain interpolation unit 74 performs the time domain interpolation by using the channel estimation value of the pilot symbols and the frequency domain interpolation value (step S206).

If σₜ≧σ_{t,th} (NO of step S202), the interpolation domain order determination unit 60 determines that the channel variation in the frequency domain is large and thus determines to perform the channel interpolation in the time domain first by using the channel estimation value of the pilot symbols. In this case, the first time domain interpolation unit 71 performs the time domain interpolation by using the channel estimation value of the pilot symbols (step S203). The first frequency domain interpolation unit 72 performs the frequency domain interpolation by using the channel estimation value of the pilot symbols and the time domain interpolation value (step S204).

As discussed above, since the second interpolation domain order determination method uses the delay spread as the channel statistics information and changes the order of interpolation between the time domain interpolation and the frequency domain interpolation based on the degree of channel variation in the frequency domain, it can improve the accuracy in the channel interpolation.

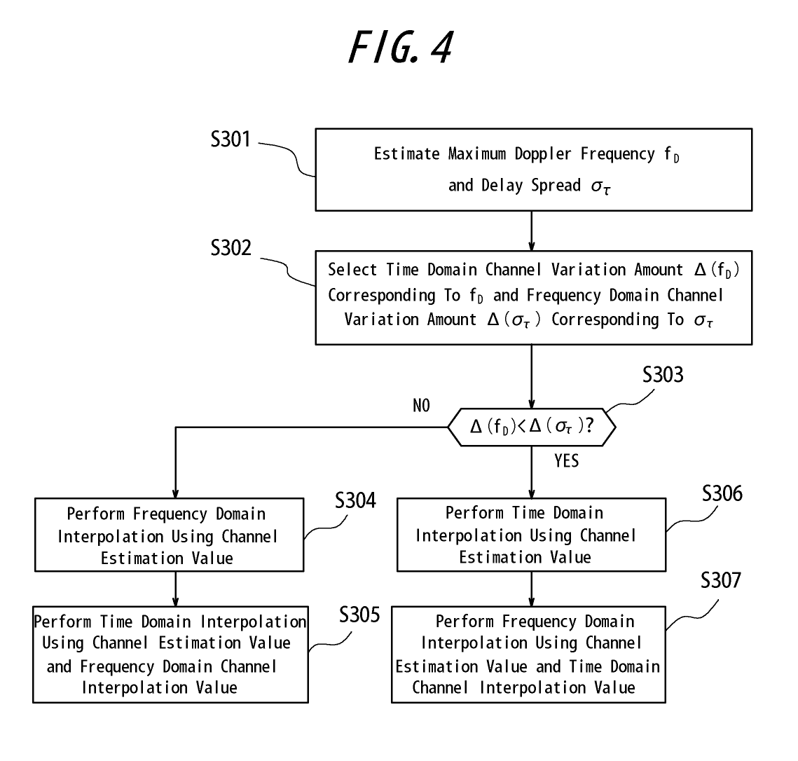

FIG. 4 is a flowchart illustrating a third interpolation domain order determination method by the radio communication apparatus 100 and illustrates processing of the interpolation domain order determination unit 60 to determine the order of the interpolation domains by using the maximum Doppler frequency and the delay spread as the channel statistics information for determining the degree of channel variation.

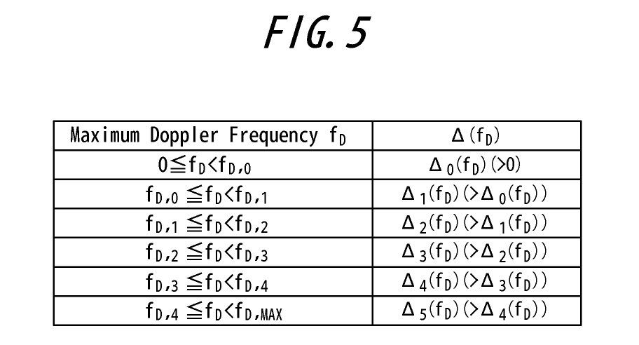

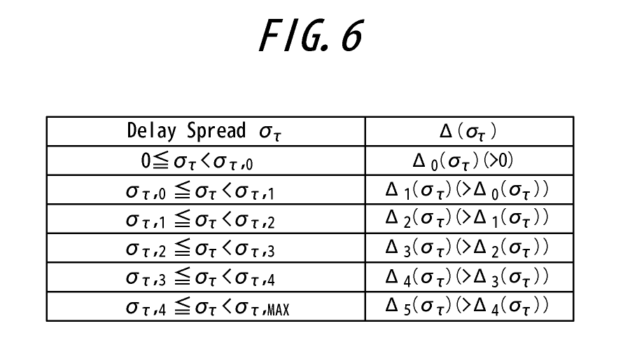

First, the delay spread estimation unit 40 and the maximum Doppler frequency estimation unit 50 estimate the delay spread σₜ and the maximum Doppler frequency f_{D}, respectively, from the received baseband OFDMA signal and output the estimated delay spread σₜ and maximum Doppler frequency f_{D} to the interpolation domain order determination unit 60 (step S301). The interpolation domain order determination unit 60 selects a time domain channel variation amount Δ(f_{D}) and a frequency domain channel variation amount Δ(σₜ) based on a table of amounts of channel variations in the time domain and a table of amounts of channel variations in the frequency domain, respectively, which are set in advance and stored in the interpolation domain order determination unit 60 (step S302). FIG. 5 shows an example of the table of amounts of channel variations in the time domain to the maximum Doppler frequencies (0≦f_{D}≦f_{D,MAX}:f_{D,MAX} indicates an estimated maximum Doppler frequency) used by the interpolation domain order determination unit 60 to select the time domain channel variation amount Δ(f_{D}). FIG. 6 shows an example of the table of amounts of channel variations in the frequency domain to the delay spreads (0≦σₜ≦σ_{t,MAX}:σ_{t,MAX} indicates an estimated maximum delay spread) used by the interpolation domain order determination unit 60 to select the frequency domain channel variation amount Δ(σₜ). Next, the interpolation domain order determination unit 60 compares the time domain channel variation amount Δ(f_{D}) and the frequency domain channel variation amount Δ(σₜ) (step S303). For the tables of the channel variation amounts, optimum values can be determined by the transmission simulation.

If Δ(f_{D})<Δ(σₜ) (YES of step S303), the interpolation domain order determination unit 60 determines that the channel variation in the time domain is smaller than the channel variation in the frequency domain and thus determines to perform the channel interpolation in the time domain first by using the channel estimation value of the pilot symbols. In this case, the first time domain interpolation unit 71 performs the time domain interpolation by using the channel estimation value of the pilot symbols (step S306). The first frequency domain interpolation unit 72 performs the frequency domain interpolation by using the channel estimation value of the pilot symbols and the time domain interpolation value (step S307).

If Δ(f_{D})≧Δ(σₜ) (NO of step S303), the interpolation domain order determination unit 60 determines that the channel variation in the frequency domain is smaller than the channel variation in the time domain and thus determines to perform the channel interpolation in the frequency domain first by using the channel estimation value of the pilot symbols. In this case, the second frequency domain interpolation unit 73 performs the frequency domain interpolation by using the channel estimation value of the pilot symbols (step S304). The second time domain interpolation unit 74 performs the time domain interpolation by using the channel estimation value of the pilot symbols and the frequency domain interpolation value (step S305).

As discussed above, since the third interpolation domain order determination method uses the maximum Doppler frequency and the delay spread as the channel statistics information and changes the order of interpolation between the time domain interpolation and the frequency domain interpolation based on the degrees of channel variations in the time domain and the frequency domain, it can improve the accuracy in the channel interpolation.

While the present invention has been described with reference to drawings and embodiments, it will be understood by those skilled in the art that many variations and modifications may be easily implemented using the teaching of the present invention. Accordingly, such variations and modifications are intended to be included in the scope of the present invention. For example, a function included in each component or each step can be rearranged avoiding a logical inconsistency, such that a plurality of components or steps are combined or divided.

For example, although the interpolation unit 70 has two time domain interpolation units and two frequency domain interpolation units in the above embodiment, the interpolation unit 70 may have only a single time domain interpolation unit and a single frequency domain interpolation unit. In this case, the interpolation unit 70 may change the order of the channel interpolation of the time domain interpolation unit and the frequency domain interpolation unit by software-like processing following the order determined by the interpolation domain order determination unit 60.

In addition, the delay spread and the maximum Doppler frequency are used as the channel statistics information for determining the degree of channel variation in the above embodiment. However, it is possible to use a time correlation function quantitatively-indicating a statistical resemblance level of a channel at one time and a channel at another time, and a frequency correlation function quantitatively-indicating a statistics resemblance level of a channel at one frequency and a channel at another frequency. In particular, the time correlation function has a variable of Δt=t₂−t₁, which is a time difference between a time t1 and a time t2 (t₁≦t2), whereas the frequency correlation function has a variable of Δf=f₂−f₁, which is a frequency difference between a frequency f1 and a frequency f2 (f₁≦f2). As a value of each correlation function increases, there is a higher possibility that the channel at one time and the channel at another time have values close to each other, and that the channel at one frequency and the channel at another frequency have values close to each other. Therefore, for example, if the time correlation function and the frequency correlation function are calculated from the received signal and a value of the time correlation frequency is larger than a threshold, the interpolation domain order determination unit determines that the channel variation in the time domain is small and thus determines to perform the channel interpolation in the time domain first by using the channel estimation value of the pilot symbols (processing thereafter is the same as the first interpolation domain order determination method). If the value of the frequency correlation function is larger than a threshold, the interpolation domain order determination unit determines that the channel variation in the frequency domain is small and thus determines to perform the channel interpolation in the frequency domain first by using the channel estimation value of the pilot symbols (processing thereafter is the same as the second interpolation domain order determination method).

As another example, it is also possible to detect a variation state in phase of pilot symbols in the time domain and a variation state in phase of pilot symbols in the frequency domain from the pilot symbols scattered in the time domain and the frequency domain, and to determine the order of the interpolation domains based on the variation states in phase detected.

### REFERENCE SIGNS LIST

100 radio communication apparatus
ANT antenna
10 guard interval removal unit
20 FFT unit
30 pilot channel estimation unit
40 delay spread estimation unit
50 maximum Doppler frequency estimation unit
60 interpolation domain order determination unit
70 interpolation unit
71 first time domain interpolation unit
72 first frequency domain interpolation unit
73 second frequency domain interpolation unit
74 second time domain interpolation unit
80 channel equalizer unit
90 additional processing unit

1. A radio communication apparatus for interpolating a channel by using pilot symbols scattered in a time domain and a frequency domain, comprising:
a pilot channel estimation unit for estimating a channel estimation value from the pilot symbols;
a channel statistics information estimation unit for estimating channel statistics information on a degree of channel variation in at least one of the time domain and the frequency domain from a received signal;
an interpolation domain order determination unit for determining an order of channel interpolation in the time domain and in the frequency domain based on the channel statistics information; and
an interpolation unit for performing the channel interpolation in the time domain and in the frequency domain, wherein
the interpolation unit, in the order determined by the interpolation domain order determination unit, first performs either of the channel interpolation in the time domain and in the frequency domain as a first channel interpolation by using the channel estimation value, and then performs channel interpolation different from the first channel interpolation in the channel interpolation in the time domain and in the frequency domain, as a second channel interpolation, by using the channel estimation value and a channel interpolation value obtained by the first channel interpolation.

2. The radio communication apparatus according to claim 1, wherein the channel statistics information estimation unit estimates a maximum Doppler frequency indicating the degree of channel variation in the time domain from the received signal,
the interpolation domain order determination unit determines the order of channel interpolation such that if the maximum Doppler frequency is smaller than a threshold, the channel interpolation in the time domain is first performed and then the channel interpolation in the frequency domain is performed, and
if the maximum Doppler frequency is larger than the threshold, the channel interpolation in the frequency domain is first performed and then the channel interpolation in the time domain is performed.

3. The radio communication apparatus according to claim 1, wherein the channel statistics information estimation unit estimates a delay spread indicating the degree of channel variation in the frequency domain from the received signal, and
the interpolation domain order determination unit determines the order of channel interpolation such that if the delay spread is smaller than a threshold, the channel interpolation in the frequency domain is first performed and then the channel interpolation in the time domain is performed, and
if the delay spread is larger than the threshold, the channel interpolation in the time domain is first performed and then the channel interpolation in the frequency domain is performed.

4. The radio communication apparatus according to claim 1, wherein the channel statistics information estimation unit estimates a maximum Doppler frequency indicating the degree of channel variation in the time domain and a delay spread indicating the degree of channel variation in the frequency domain and obtains a channel variation amount in the time domain corresponding to the maximum Doppler frequency and a channel variation amount in the frequency domain corresponding to the delay spread, and
the interpolation unit determines the order of channel interpolation such that if the channel variation amount in the time domain is smaller than the channel variation amount in the frequency domain, the channel interpolation in the time domain is first performed, and then the channel interpolation in the frequency domain is performed, and
if the channel variation in the frequency domain is smaller than the channel variation in the time domain, the channel interpolation in the frequency domain is first performed and then the channel interpolation in the time domain is performed.

5. A radio communication method for interpolating a channel by using pilot symbols scattered in a time domain and a frequency domain, comprising the steps of:
estimating a channel estimation value from the pilot symbols;
estimating channel statistics information on a degree of channel variation in at least one of a time domain and a frequency domain from a received signal;
determining an order of interpolation domain to determine an order of channel interpolation in the time domain and in the frequency domain based on the channel statistics information; and
performing channel interpolation in the time domain and in the frequency domain, wherein
at the step of performing interpolation, in the order determined at the step of determining the order of interpolation domain, either of the channel interpolation in the time domain and in the frequency domain is first performed as a first channel interpolation by using the channel estimation value, and then channel interpolation different from the first channel interpolation in the channel interpolation in the time domain and in the frequency domain is performed as a second channel interpolation by using the channel estimation value and a channel interpolation value obtained by the first channel interpolation.
